(19) United States
(12) Patent Application Publication
(10) Pub. No.: US 2008/0139691 A1
(43) Pub. Date: Jun. 12, 2008

(54) UV-curable polyurethane dispersions

(76) Inventors: Harald Blum, Leverkusen (DE); Richard Kopp, Koln (DE); Stefan Sommer, Leverkusen (DE); Christoph Irle, Dormagen (DE)

Correspondence Address: BAYER MATERIAL SCIENCE LLC, 100 BAYER ROAD, PITTSBURGH, PA, 15205, US

(21) Appl. No.: 11/975,092

(22) Filed: Oct. 17, 2007

(30) Foreign Application Priority Data
Oct. 21, 2006 (DE) 10 2006 049 764.3

(51) Int. Cl. C08J 3/28; C08G 18/67; C08L 75/06

(52) U.S. Cl. 522/90; 528/75; 528/44

(57) ABSTRACT

The invention relates to novel UV-curable polyurethane dispersions based on unsaturated polyesters modified with dicyclopentadiene, the preparation of these polyurethane dispersions and the use thereof as a lacquer, coating and/or adhesive.

### CROSS-REFERENCE TO RELATED APPLICATIONS

The present application claims the right of priority under 35 U.S.C. § 119 (a)-(d) of German Patent Application Number 10 2006 049 764.3, filed Oct. 21, 2006.

### BACKGROUND OF THE INVENTION

The invention relates to novel UV-curable polyurethane dispersions based on unsaturated polyesters modified with dicyclopentadiene, the preparation of these polyurethane dispersions and the use thereof as a lacquer, coating and/or adhesive.

DE-A 102 06 565 describes water-dilutable polyurethanes for oxidatively drying or UV-curable coating compositions which contain structural units derived from 3,4-epoxy-1-butene, the corresponding unsaturated polyether structural units being present in the polymer in blocks and optionally together with (meth)acrylic acid structural units or unsaturated fatty acid structural units. Disadvantages of the products described there is that they do not display an adequate warmth and brilliance on wood, and the pendulum hardness of the cured films is too low, which necessitates post-curing by storage.

DE-A 40 11 349 discloses unsaturated polyester polyurethanes which contain polyesters containing specific allyl ether and polyalkylene glycol groupings. The products contain relatively high amount of polyalkylene glycol groupings and lead to coating having relatively low hardnesses and non-optimum resistance properties, in particular to coloring liquids and water.

U.S. Pat. No. 5,095,069 discloses thermosetting, high molecular weight aqueous polyurethanes which contain side-chain allyl ether groups and additionally other unsaturated groups which can react internally with the allyl ether groups in the polymer backbone. The polymers are cured by stoving at relatively high temperatures. Furthermore, these products have only an inadequate warmth and brilliance on wood.

DE-A 195 25 489 discloses polyester acrylate urethane dispersions which are based on polyester acrylate prepolymers and can be processed to coatings with good physical drying, high hardness and good resistance to chemicals. However, the optical properties of films, in particular the warmth and brilliance on wood, do not achieve the level necessary for many uses.

EP-A 1 142 947 describes physically drying polyurethane dispersions having an improved warmth and brilliance, which contain 2,2-dimethyl-3-hydroxypropionic acid (2,2-dimethyl-3-hydroxypropyl ester). Nevertheless, the improvement in warmth and brilliance mentioned there is still not yet adequate for many uses.

For a number of uses, the aqueous UV-curable polyurethane dispersions known to date in lacquer technology have the disadvantage that they either dry by physical means, but then do not result in an optimum warmth and brilliance on wood substrates, or before complete curing they render possible tacky, sensitive films without physical drying with a better warmth and brilliance.

The object of the present invention was therefore to provide aqueous polyurethane dispersions which can be cured by high-energy radiation, in particular UV radiation, contain as little organic solvent as possible, display physical drying at room temperature, show an excellent warmth and brilliance on wood substrates, adhere very well and result in films of high hardness. Furthermore, the dispersions according to the invention should be processable to coatings which are resistant to exposure to substances such as water, alcohol, red wine and coffee.

It has been found, surprisingly, that polyurethane dispersions which contain unsaturated polyester resins modified with dicyclopentadiene meet the requirements imposed.

### SUMMARY OF THE INVENTION

The invention provides aqueous polyurethane dispersions prepared from unsaturated polyester resins modified with dicyclopentadiene.

### DETAILED DESCRIPTION OF THE PREFERRED EMBODIMENTS

The polyurethane dispersions according to the invention contain reaction products of

a) at least one unsaturated polyester resin modified with dicyclopentadiene,
b) at least one at least difunctional polyisocyanate and
c) at least one hydrophilizing component.

The polyurethane dispersion according to the invention optionally contain one or more components chosen from the group consisting of

d) polymers and/or monomers containing unsaturated groups,
e) oligomers, polymers and/or monomers containing hydroxyl and/or amino groups and
f) mono-, di-, polyamines and/or hydroxyamines.
The polyurethane dispersions according to the invention contain reaction products of
   3 to 50 wt. %, preferably 3 to 35 wt. % of component a), 7 to 50 wt. %, preferably 12 to 40 wt. % of component b), 1 to 25 wt. %, preferably 1 to 10 wt. % of component c), 10 to 75 wt. %, preferably 30 to 65 wt. % of component d), 0 to 40 wt. %, preferably 0 to 20 wt. % of component e) and 0.1 to 6 wt. %, preferably 0.25 to 4 wt. % of component f),
   the percentage data for a) to f) adding up to 100 wt. %.

Preferably, the polyurethane dispersions according to the invention contain reaction products of
a) at least one unsaturated polyester resin modified with dicyclopentadiene,
b) at least one at least difunctional polyisocyanate,
c) at least one hydrophilizing component having at least one hydroxyl, amino and/or thio group and at least one ionic or potentially ionic group and/or ethylene oxide, ethylene oxide/propylene oxide copolymer and/or block copolymer structural units,
d) at least one component chosen from the group consisting of (poly)ester (meth)acrylates, (poly)ether (meth)acrylates, (poly)urethane (meth)acrylates, (poly)epoxy(meth)acrylates, (poly)ether ester (meth)acrylates and unsaturated polyesters having allyl ether structural units,
e) optionally hydroxy-functional diols and/or triols of molecular weight 62 to 242 and/or hydroxy-functional oligomers or polymers, such as polyesters, polycarbonates, polyurethanes, C2-, C3- and/or C4-polyethers, polyether esters and polycarbonate polyesters of number-average molecular weight 700 to 4,000 g/mol and
f) at least one mono-, di- and/or polyamine and/or hydroxyamine.

The abovementioned polyurethane dispersions according to the invention which are particularly preferred are those in which

component a) is at least one unsaturated polyester resin which is modified with 5 to 35 wt. % of dicyclopentadiene,
component b) is at least one at least difunctional polyisocyanate which comprises aliphatic and/or cycloaliphatic polyisocyanates to the extent of at least 60 wt. %,
component d) is at least one compound chosen from the group consisting of polyester acrylates, polyether acrylates, polyepoxyacrylates, urethane acrylates and/or polyether ester acrylates, which also contains hydroxyl groups in addition to the unsaturated groups.

Preferably, the polyurethane dispersions according to the invention contain at least one initiator and optionally further auxiliary substances and additives which render possible or accelerate curing with high-energy radiation, such as e.g. electron beams or UV rays.

Suitable initiators are e.g. photoinitiators which can be activated by UV or visible light. Photoinitiators are commercially marketed compounds which are known per se, a distinction being made between unimolecular (type I) and bimolecular (type II) initiators. Suitable (type I) systems are those such as aromatic ketone compounds, e.g. benzophenones in combination with tertiary amines, alkylbenzophenones, 4,4′-bis(dimethylamino)benzophenone (Michler's ketone), anthrone and halogenated benzophenones or mixtures of the types mentioned. (Type II) initiators are furthermore suitable, such as benzoin and its derivatives, benzil ketals, acylphosphine oxides, e.g. 2,4,6-trimethyl-benzoyl-diphenylphosphine oxide, bisacylphosphine oxides, phenylglyoxylic acid esters, camphorquinone, α-aminoalkylphenones, α,α-dialkoxyacetophenones and α-hydroxyalkylphenones. Photoinitiators which can easily be incorporated into aqueous coating compositions are preferred. Such products are, for example, Irgacure® 500, Irgacure® 819 DW (Ciba, Lampertheim, DE) and Esacure® KIP (Lamberti, Aldizzate, Italy). Mixtures of these compounds can also be employed.

The unsaturated polyester resins a) modified with dicyclopentadiene are obtained by esterification or transesterification of

a1) hydroxy-functional di-, tri- or polyols with
a2) carboxyl- or anhydride-functional raw materials with
a3) dicyclopentadiene and
a4) optionally further raw materials.

Suitable hydroxy-functional di-, tri- or polyols a1) are e.g. ethylene glycol, diethylene glycol, triethylene glycol, tetraethylene glycol, propylene glycol, dipropylene glycol, tripropylene glycol, 1,2-butanediol, 1,3-butanediol, 1,4-butanediol, neopentyl glycol, hexanediol, 1,4-cyclohexane-dimethanol, 1,4-dihydroxycyclohexane, trimethylolpropane, glycerol, pentaerythritol, benzyl alcohol, 2-ethylhexyl alcohol, butyl diglycol, butyl glycol and also reaction products of the hydroxy-functional compounds mentioned with ethylene oxide and/or propylene oxide.

Preferred components a1) are ethylene glycol, diethylene glycol, triethylene glycol, propylene glycol, dipropylene glycol, butyl diglycol, neopentyl glycol, butanediol and/or hexanediol.

Suitable carboxy- or anhydride-functional raw materials a2) are maleic anhydride, fumaric acid, phthalic anhydride, isophthalic acid, terephthalic acid, hexahydrophthalic anhydride, succinic acid, adipic acid, soya oil fatty acid, oleic acid, tetrahydrophthalic anhydride, benzoic acid, 2-ethylhexanoic acid or saturated C₈- to C₂₀-monocarboxylic acids.

Preferred raw materials a2) are maleic anhydride, phthalic anhydride, fumaric acid, tetrahydrophthalic anhydride and/or adipic acid, component a2) particularly preferably always containing at least a proportion of maleic anhydride.

Further raw materials a4) optionally contained can be e.g. trimethylolpropane mono- and/or trimethylolpropane diallyl ether, glycidyl methacrylate, acrylic acid, methacrylic acid, soya oil and other naturally occurring oils.

The unsaturated polyester resins a) modified with dicyclopentadiene are preferably reaction products of

a1) 30 to 65 wt. % of hydroxy-functional di-, tri- or polyols with
a2) 25 to 65 wt. % of carboxyl- or anhydride-functional raw materials with
a3) 5 to 35 wt. % of dicyclopentadiene,
the percentage data for a1) to a3) adding up to 100 wt. %.

The unsaturated polyester resins containing dicyclopentadiene groups are obtained by esterification processes which are known per se, which are carried out in one or preferably several stages at temperatures of from 140 to 220° C., water being split off.

For example, component a) can be prepared by a procedure in which, in a first reaction step, a half-ester is formed from an acid anhydride, such as e.g. maleic anhydride, and a diol, such as e.g. diethylene glycol, at 140-150° C., and is then reacted with dicyclopentadiene at 140° C. Further diol, e.g. a mixture of diethylene glycol and ethylene glycol, and a stabilizer (e.g. toluhydroquinone) are then added, the mixture is heated to 190° C. and esterification is carried out until the desired acid number, hydroxyl number and/or viscosity of the unsaturated polyester resin is reached. After cooling, stabilization is carried out again (e.g. with toluhydroquinone and trimethylhydroquinone) and, optionally after dissolving in acetone, the product is transferred to containers.

An azeotropic entraining agent, such as e.g. isooctane, isononane, toluene, xylene or cyclohexane, can optionally also be employed.

The esterification is conventionally carried out until a certain acid number and/or a certain hydroxyl number is reached, and optionally also until a certain viscosity is reached.

Stabilizers are conventionally added for stabilization purposes, such as e.g. toluhydroquinone, trimethylhydroquinone and/or di-tert-butylhydroquinone.

Suitable at least difunctional polyisocyanates b) are, for example, 1,3-cyclohexane-diisocyanate, 1-methyl-2,4-diisocyanato-cyclohexane, 1-methyl-2,6-diisocyanato-cyclohexane, tetramethylene-diisocyanate, 4,4′-diisocyanatodiphenylmethane, 2,4′-diisocyanatodiphenylmethane, 2,4-diisocyanatotoluene, 2,6-diisocyanatotoluene, α,α,α′,α′-tetramethyl-m- or p-xylylene-diisocyanate, 1,6-hexamethylene-diisocyanate, 1-isocyanato-3,3,5-trimethyl-5-isocyanatomethylcyclohexane (isophorone-diisocyanate) and 4,4′-diisocyanato-dicyclohexylmethane, and mixtures thereof, optionally also with other isocyanates and/or higher-functionality homologues or oligomers with urethane, biuret, carbodiimide, isocyanurate, allophanate, iminooxadiazinedione and/or uretdione groups.

Preferably, the polyisocyanate component b) contains at least 60 wt. % of cycloaliphatic and/or aliphatic, at least difunctional isocyanates.

The polyisocyanate component b) particularly preferably contains isophorone-diisocyanate, 1-methyl-2,4/(2,6)-diisocyanatocyclohexane, 4,4′-diisocyanatodicyclohexylmethane and/or 1,6-hexamethylene-diisocyanate, optionally in combination with 2,4-diisocyanatotoluene or 2,6-diisocyanatotoluene.

Component c) is preferably a hydrophilizing component having at least one hydroxyl, amino and/or thio group and at least one ionic or potentially ionic group and/or nonionic groups having a hydrophilizing action, such as e.g. C₂- or C₂/C₃-polyether groups.

In this context, preferably suitable isocyanate-reactive groups are hydroxyl and amino groups.

Ionic or potentially ionic groups are understood as meaning functionalities such as e.g. —COOY, —SO₃Y, —PO(OY)₂ (Y for example ═H, NH₄⁺, metal cation) and —NR₂, —NR₃⁺ (R═H, alkyl, aryl), which enter into a pH-dependent dissociation equilibrium on interaction with aqueous media and can be negatively, positively or neutrally charged in this manner.

Suitable ionic or potentially ionic compounds c) are e.g. mono- and dihydroxycarboxylic acids, mono- and diaminocarboxylic acids, mono- and dihydroxysulfonic acids, mono- and diaminosulfonic acids and mono- and dihydroxyphosphonic acids or mono- and diaminophosphonic acids and their salts, such as dimethylolpropionic acid, dimethylolbutyric acid, hydroxypivalic acid, N-(2-aminoethyl)-alanine, 2-(2-amino-ethylamino)-ethanesulfonic acid, ethylenediamine-propyl- or butylsulfonic acid, 1,2- or 1,3-propylenediamine-ethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, Example 1) and alkali metal and/or ammonium salts thereof; the adduct of sodium bisulfite on butene-2-diol 1,4-polyether-sulfonate, the propoxylated adduct of 2-butenediol and NaHSO₄, e.g. described in DE-A 2 446 440 (page 5-9), formula I-III) and units which can be converted into cationic groups, such as N-methyl-diethanolamine, as a hydrophilic structural component. Preferred ionic or potentially ionic compounds are those which have carboxyl or carboxylate and/or sulfonate groups and/or ammonium groups. Particularly preferred ionic compounds are those which contain carboxyl and/or sulfonate groups as ionic or potentially ionic groups, such as the salts of 2-(2-amino-ethylamino)-ethanesulfonic acid or of the addition product of IPDI and acrylic acid (EP-A 0 916 647, Example 1) and of dimethylolpropionic acid.

Suitable compounds having a nonionically hydrophilizing action are e.g. polyoxyalkylene ethers which contain at least one hydroxyl or amino group. These polyethers have a content of 30 wt. % to 100 wt. % of units which are derived from ethylene oxide. Polyethers of linear structure and having a functionality of between 1 and 3 are possible, and also compounds of the general formula (I)

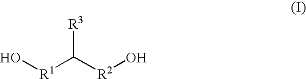

in which
R¹ and R² independently of one another in each case denote a divalent aliphatic, cycloaliphatic or aromatic radical having 1 to 18 C atoms, which can be interrupted by oxygen and/or nitrogen atoms, and
R³ represents an alkoxy-terminated polyethylene oxide radical.

Compounds having a nonionically hydrophilizing action are, for example, also monofunctional polyalkylene oxide polyether alcohols having a statistical average of 5 to 70, preferably 7 to 55 ethylene oxide units per molecules, such as are accessible in a manner known per se by alkoxylation of suitable starter molecules (e.g. in Ullmanns Encyclopädie der technischen Chemie, 4th edition, volume 19, Verlag Chemie, Weinheim p. 31-38).

Suitable starter molecules are, for example, saturated monoalcohols, such as methanol, ethanol, n-propanol, isopropanol, n-butanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, such as, for example, diethylene glycol monobutyl ether, unsaturated alcohols, such as allyl alcohol, 1,1-dimethylallyl alcohol or oleyl alcohol, aromatic alcohols, such as phenol, the isomeric cresols or methoxyphenols, araliphatic alcohols, such as benzyl alcohol, anisyl alcohol or cinnamyl alcohol, secondary monoamines, such as dimethylamine, diethylamine, dipropylamine, diisopropylamine, dibutylamine, bis-(2-ethylhexyl)-amine, N-methyl- and N-ethylcyclohexylamine or dicyclohexylamine, and heterocyclic secondary amines, such as morpholine, pyrrolidine, piperidine or 1H-pyrazole. Preferred starter molecules are saturated monoalcohols. Diethylene glycol monomethyl, monoethyl or monobutyl ether are particularly preferably used as starter molecules.

Alkylene oxides which are suitable for the alkoxylation reaction are, in particular, ethylene oxide and propylene oxide, which can be employed in the alkoxylation reaction in any desired sequence or also in a mixture.

The polyalkylene oxide polyether alcohols are either pure polyethylene oxide polyethers or mixed polyalkylene oxide polyethers, the alkylene oxide units of which comprise ethylene oxide units to the extent of at least 30 mol %, preferably to the extent of at least 40 mol %. Preferred nonionic compounds are monofunctional mixed polyalkylene oxide polyethers which contains at least 40 mol % of ethylene oxide units and not more than 60 mol % of propylene oxide units.

The acids mentioned are converted into the corresponding salts by reaction with neutralizing agents, such as e.g. triethylamine, ethyldiisopropylamine, dimethylcyclohexylamine, dimethylethanolamine, ammonia, N-methylmorpholine, NaOH and/or KOH. In this context, the degree of neutralization is between 50 and 125%.

Suitable monomers, oligomers and/or polymers d) containing unsaturated groups are e.g. (poly)ester (meth)acrylates, (poly)ether (meth)acrylates, (poly)epoxy-(meth)acrylates, (poly)ether ester (meth)acrylates, (poly)urethane (meth)acrylates, unsaturated polyesters having allyl ether structural units and combinations of the compounds mentioned.

Component d) contains double bonds which can be polymerized by free-radical polymerization, preferably those of hydroxy-functional acrylates and/or methacrylates. Examples are 2-hydroxyethyl(meth)acrylate, polyethylene oxide mono(meth)acrylates, polypropylene oxide mono(meth)acrylates, polyalkylene oxide mono(meth)acrylates, poly(ε-caprolactone) mono(meth)acrylates, such as e.g. Tone® M100 (Union Carbide, USA), 2-hydroxypropyl(meth)acrylate, 4-hydroxybutyl(meth)acrylate, 3-hydroxy-2,2-dimethylpropyl(meth)acrylate, the mono-, di-, tri- or tetraacrylates of polyhydric alcohols, such as trimethylolpropane, glycerol, pentaerythritol, dipentaerythritol, ethoxylated, propoxylated or alkoxylated trimethylolpropane, glycerol, pentaerythritol, dipentaerythritol or technical grade mixtures thereof.

Alcohols which can be obtained from the reaction of acids containing double bonds with monomeric epoxide compounds which optionally contain double bonds, thus e.g. the reaction products of (meth)acrylic acid with glycidyl (meth)acrylate or with the glycidyl ester of versatic acid, are also suitable.

Isocyanate-reactive, oligomeric or polymeric unsaturated compounds containing acrylate and/or methacrylate groups can furthermore be employed as component d), by themselves or in combination with the abovementioned monomeric compounds. Polyester acrylates having an OH content of from 30 to 300 mg KOH/g, preferably from 60 to 200 mg KOH/g, particularly preferably from 70 to 120 mg KOH/g are preferably employed as component d).

A total of 7 groups of monomer constituents can be used in the preparation of the hydroxy-functional polyesters acrylates d):
1. (Cyclo)alkanediols, such as dihydric alcohols having (cyclo)aliphatically bonded hydroxyl groups of number-average molecular weight range 62 to 286, e.g. ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol and diols containing ether oxygen, such as e.g. diethylene glycol, triethylene glycol, tetraethylene glycol, dipropylene glycol, tripropylene glycol and polyethylene, polypropylene or polybutylene glycols having a number-average molecular weight of from 200 to 4,000, preferably 300 to 2,000, particularly preferably 450 to 1,200. Reaction products of the abovementioned diols with ε-caprolactone or other lactones can likewise be employed as diols.
2. Alcohols which are trihydric or more than trihydric of number-average molecular weight range 92 to 254, such as e.g. glycerol, trimethylolpropane, pentaerythritol, dipentaerythritol and sorbitol, or polyethers started on these alcohols, such as e.g. the reaction product of 1 mol of trimethylolpropane with 4 mol of ethylene oxide.
3. Monoalcohols, such as e.g. ethanol, 1- and 2-propanol, 1- and 2-butanol, 1-hexanol, 2-ethylhexanol, cyclohexanol and benzyl alcohol.
4. Dicarboxylic acids of number-average molecular weight range 104 to 600 and/or anhydrides thereof, such as e.g. phthalic acid, phthalic anhydride, isophthalic acid, tetrahydrophthalic acid, tetrahydrophthalic anhydride, hexahydrophthalic acid, hexahydrophthalic anhydride, cyclohexanedicarboxylic acid, maleic anhydride, fumaric acid, malonic acid, succinic acid, succinic anhydride, glutaric acid, adipic acid, pimelic acid, suberic acid, sebacic acid, dodecanedioic acid and hydrogenated dimer fatty acids.
5. Carboxylic acids of higher functionality and anhydrides thereof, such as e.g. trimellitic acid and trimellitic anhydride.
6. Monocarboxylic acids, such as e.g. benzoic acid, cyclohexanecarboxylic acid, 2-ethylhexanoic acid, caproic acid, caprylic acid, capric acid, lauric acid and natural and synthetic fatty acids.
7. Acrylic acid, methacrylic acid and dimeric acrylic acid.

Suitable polyester acrylates d) containing hydroxyl groups contain the reaction product of at least one constituent from group 1 or 2 with at least one constituent from group 4 or 5 and at least one constituent from group 7.

Preferred constituents from group 1) are: ethanediol, 1,2- and 1,3-propanediol, 1,4-butanediol, 1,6-hexanediol, neopentyl glycol, cyclohexane-1,4-dimethanol, 1,2- and 1,4-cyclohexanediol, 2-ethyl-2-butylpropanediol and diols containing ether oxygen, such as e.g. diethylene glycol, triethylene glycol, tetraethylene glycol, dipropylene glycol and tripropylene glycol.

Preferred constituents from group 2) are: glycerol, trimethylolpropane, pentaerythritol or polyethers started on these alcohols, such as e.g. the reaction product of 1 mol of trimethylolpropane with 4 mol of ethylene oxide.

Preferred constituents from groups 4) and 5) are: phthalic anhydride, isophthalic acid, tetrahydrophthalic anhydride, hexahydrophthalic acid, hexahydrophthalic anhydride, maleic anhydride, fumaric acid, succinic anhydride, glutaric acid, adipic acid, dodecanedioic acid, hydrogenated dimer fatty acids and trimellitic anhydride.

The preferred constituent from group 7) is acrylic acid.

Groups having a dispersing action which are generally known from the prior art can optionally be incorporated into these polyester acrylates. Thus, polyethylene glycols and/or methoxypolyethylene glycols can be co-used as a proportion of the alcohol component. Compounds which may be mentioned are, for example, polyethylene glycols, polypropylene glycols and block copolymers thereof started on alcohols, and the monomethyl ethers of these polyglycols. Polyethylene glycol 1500- and/or polyethylene glycol 500-monomethyl ether is particularly suitable.

It is furthermore possible to react some of the carboxyl groups, in particular those of (meth)acrylic acid, with mono-, di- or polyepoxides after the esterification. Preferred compounds are, for example, the epoxides (glycidyl ethers) of monomeric, oligomeric or polymeric bisphenol A, bisphenol F, hexanediol and/or butanediol or ethoxylated and/or propoxylated derivatives thereof. This reaction can be used, in particular, to increase the OH number of the polyester (meth)acrylate, since in the epoxide-acid reaction in each case an OH group is formed. The acid number of the resulting product is between 0 and 20 mg KOH/g, preferably between 0 and 10 mg KOH/g and particularly preferably between 0 and 5 mg KOH/g. The reaction is preferably catalyzed by catalysts, such as triphenylphosphine, thiodiglycol, ammonium and/or phosphonium halides and/or compounds of zirconium or tin, such as tin(II) ethylhexanoate.

The preparation of polyester acrylates is described in DE-A 4 040 290 (p. 3, 1. 25-p. 6, 1. 24), DE-A-3 316 592 (p. 5, 1. 14-p. 11, 1. 30) and P. K. T. Oldring (ed.), Chemistry & Technology of UV & EB Formulations For Coatings, Inks & Paints, vol. 2, 1991, SITA Technology, London, p. 123-135.

Compounds which are likewise preferred as component d) are the epoxy(meth)acrylates containing hydroxyl groups which are known per se and have OH contents of from 20 to 300 mg KOH/g, preferably from 100 to 280 mg KOH/g, particularly preferably from 150 to 250 mg KOH/g, or (poly)urethane (meth)acrylates containing hydroxyl groups and having OH contents of from 20 to 300 mg KOH/g, preferably from 40 to 150 mg KOH/g, particularly preferably from 50 to 100 mg KOH/g, and mixtures thereof with one another and mixtures with unsaturated polyesters containing hydroxyl groups and mixtures with polyester (meth)acrylates or mixtures of unsaturated polyesters containing hydroxyl groups with polyester (meth)acrylates. Such compounds are likewise described in P. K. T. Oldring (ed.), Chemistry & Technology of UV & EB Formulations For Coatings, Inks & Paints, vol. 2, 1991, SITA Technology, London, p. 37-56. Epoxy(meth)acrylates containing hydroxyl groups are based in particular on reaction products of acrylic acid and/or methacrylic acid with epoxides (glycidyl compounds) of monomeric, oligomeric or polymeric bisphenol A, bisphenol F, hexanediol and/or butanediol or ethoxylated and/or propoxylated derivatives thereof.

(Poly)ether acrylates, which are reaction products of acrylic and/or methacrylic acid with polyethers having free hydroxyl groups, are likewise suitable as component d). The polyethers are e.g. homo-, co- or block copolymers of ethylene oxide, propylene oxide and/or tetrahydrofuran on any desired hydroxy- and/or amine-functional starter molecules, such as e.g. trimethylolpropane, diethylene glycol, dipropylene glycol, glycerol, pentaerythritol, neopentyl glycol, butanediol and/or hexanediol.

Component d) preferably also comprises, in addition to the unsaturated compounds, NCO-reactive compounds, in particular hydroxyl groups. Partial or complete incorporation into the polyurethane dispersion is possible via these hydroxyl groups. It is also possible to employ various components d) with and without hydroxyl groups simultaneously, which leads to some of component d) being incorporated into the polyurethane and some, if it does not contain incorporated hydrophilic groups, being dispersed through the polyurethane, which in this case acts as a polymeric emulsifier.

Preferred components d) are compounds chosen from the group consisting of polyester acrylates, polyether acrylates, polyepoxyacrylates, urethane acrylates and/or polyether ester acrylates, which also contain hydroxyl groups, in addition to the unsaturated groups.

Hydroxy-functional polyester acrylates, polyether acrylates and polyepoxyacrylates are particularly preferred as component d).

Suitable oligomers, polymers and/or monomers e) containing hydroxyl and/or amino groups are e.g.:
1) Low molecular weight polyols, such as e.g. aliphatic, araliphatic or cycloaliphatic diols or triols containing 2 to 20 carbon atoms. Examples of diols are ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, position isomer diethyloctanediols, 1,3-butylene glycol, cyclohexanediol, 1,4-cyclohexanedimethanol, 1,6-hexanediol, 1,2- and 1,4-cyclohexanediol, hydrogenated bisphenol A (2,2-bis(4-hydroxycyclohexyl)propane) and 2,2-dimethyl-3-hydroxypropionic acid (2,2-dimethyl-3-hydroxypropyl ester). 1,4-Butanediol, 1,4-cyclohexanedimethanol and 1,6-hexanediol are preferred.
2) Oligomeric or higher molecular weight polyols, such as e.g. di- or polyols or amino alcohols having a number-average molecular weight in the range of from 500 to 13,000 g/mol, preferably 700 to 4,000 g/mol, such as e.g. hydroxy-functional oligomers or polymers, such as polyesters, polycarbonates, polyurethanes, C2-, C3- and/or C4-polyethers, polyether esters or polycarbonate polyesters. Polymers having an average hydroxyl functionality of from 1.5 to 3.5, preferably from 1.8 to 2.5 are preferred.

Suitable polyester alcohols are those based on aliphatic, cycloaliphatic and/or aromatic di-, tri- and/or polycarboxylic acids with di-, tri- and/or polyols and polyester alcohols based on lactones. Preferred polyester alcohols are e.g. reaction products of adipic acid, isophthalic acid and phthalic anhydride with hexanediol, butanediol, diethylene glycol, monoethylene glycol or neopentyl glycol or mixtures of the diols mentioned of number-average molecular weight of from 500 to 4,000, preferably 800 to 2,500.

Polyether-ols, which are obtainable by polymerization of cyclic ethers or by reaction of alkylene oxides with a starter molecule, are likewise suitable.

Examples which may be mentioned are the polyethylene and/or polypropylene glycols of a number-average molecular weight of from 500 to 13,000, and furthermore polytetrahydrofurans of a number-average molecular weight of from 500 to 8,000, preferably from 800 to 3,000.

Hydroxyl-terminated polycarbonates, which are accessible by reaction of diols or also lactone-modified diols or also bisphenols, such as e.g. bisphenol A, with phosgene or carbonic acid diesters, such as diphenyl carbonate or dimethyl carbonate, are likewise suitable. Examples which may be mentioned are the polymeric carbonates of 1,6-hexanediol of average molecular weight of from 500 to 8,000, and the carbonates of reaction products of 1,6-hexanediol with ε-caprolactone in the molar ratio of from 1 to 0.1. The above-mentioned polycarbonate diols of average molecular weight of from 800 to 3,000 based on 1,6-hexanediol and/or carbonates of reaction products of 1,6-hexanediol with ε-caprolactone in the molar ratio of from 1 to 0.33 are preferred.

Hydroxyl-terminated polyamide alcohols and hydroxyl-terminated polyacrylate diols, e.g. Tegomer® BD 1000 (Tego GmbH, Essen, DE), can likewise be employed.

The polyurethane dispersions according to the invention preferably contain as component d) hydroxy-functional polyester alcohols and/or hydroxyl-terminated polycarbonates and/or hydroxy-functional C4-polyethers.

Suitable mono-, di-, polyamines and/or hydroxyamines f) are employed to increase the molar mass, but can also be used to limit the molar mass or for branching of the polymer, and are preferably added towards the end of the polyaddition reaction. This reaction can be carried out in an organic phase and/or in an aqueous medium. The di- and/or polyamines are conventionally more reactive than water towards the isocyanate groups of component b). Examples which may be mentioned are ethylenediamine, 1,3-propylenediamine, 1,6-hexamethylenediamine, hydrazine, isophoronediamine, 1,3- and 1,4-phenylenediamine, 4,4′-diphenylmethanediamine, amino-functional polyethylene oxides or polypropylene oxides, which are obtainable under the name Jeffamin®, D series (Huntsman Corp. Europe, Belgium), alkoxysilane group-containing mono- or diamines, diethylenetriamine, triethylenetetramine and hydrazine. Isophoronediamine, ethylenediamine and/or 1,6-hexamethylenediamine are preferred. Ethylenediamine is particularly preferred.

A proportion of monoamines, such as e.g. butylamine, ethylamine and amines of the Jeffamin® M series (Huntsman Corp. Europe, Belgium), and amino-functional polyethylene oxides and polypropylene oxides can also be added.

The preparation of the polyurethane dispersions according to the invention can be carried out in various ways:

In one possible embodiment of the process according to the invention, components a), c), optionally d) and e), optionally in organic solution, are reacted with an excess of component b) in one reaction step to give an isocyanate-functional prepolymer, it being possible for the neutralizing agent for producing the ionic groups necessary for the dispersing to be added before, during or after this prepolymer preparation, followed by the dispersing step by addition of water to the prepolymer or transfer of the prepolymer into an aqueous reservoir. A chain lengthening can then be carried out by addition of component f), and optionally removal of the solvent by distillation.

A further embodiment of the preparation process according to the invention is the reaction of components a), c), optionally d) and e), optionally in organic solution, with an excess of component b) in one reaction step to give an isocyanate-functional prepolymer, it being possible for the neutralizing agent for producing the ionic groups necessary for the dispersing to be added before, during or after this prepolymer preparation, followed by a chain lengthening step by addition of component f), and followed by the dispersing step by addition of water to the prepolymer or transfer of the prepolymer into an aqueous reservoir. The removal of the solvent by distillation can then be carried out.

A further embodiment of the preparation process according to the invention likewise comprises preparing the prepolymer in a multi-stage process in which in a first reaction step components a) and c) are reacted with an excess of component b) and this intermediate product is then reacted in a second reaction step with component d) and/or e), followed by dispersing and chain lengthening with component f) or followed by chain lengthening and dispersing, it being possible for the neutralizing agent to be added at any desired point of the reaction procedure before or also during the dispersing step. The removal of the solvent by distillation can then be carried out.

Multi-stage processes are of course also possible in another sequence of the reaction of the components.

It is likewise possible to carry out the dispersing step and distillation step in parallel, that is to say simultaneously.

The preparation of the polyurethane dispersions according to the invention is conventionally carried out at 20 to 150° C., preferably at 25 to 75° C.

Suitable solvents are in principle all solvents or solvent mixtures which do not react with the reaction components, such as e.g. N-methylpyrrolidone, N-ethylpyrrolidone, butyl acetate, ethyl acetate, methoxypropyl acetate, diethylene glycol dimethyl ether, dioxane, dimethylformamide, xylene, toluene, solvent naphtha, cyclohexanone, methyl isobutyl ketone, diethyl ketone, methyl ethyl ketone or acetone. The solvents can then be completely or partly removed by distillation. It is also possible to add further solvents, e.g. hydroxy-functional solvents, such as e.g. butyl diglycol, methoxypropanol or butyl glycol, after preparation of the dispersion according to the invention.

The preparation in acetone with subsequent removal of the solvent by distillation after preparation of the dispersion or during the dispersing step is preferred. The polyurethane dispersions according to the invention contain less than 5 wt. %, preferably less than 1 wt. % and particularly preferably less than 0.5 wt. % of organic solvents.

The process according to the invention can be carried out with the use of certain catalysts. Suitable catalysts are in principle all those which catalyze the reaction of isocyanate groups with hydroxyl groups, such as e.g. tertiary amines, and compounds of tin, zinc or bismuth, in particular triethylamine, ethyldiisopropylamine, dimethylcyclohexylamine, N-methylmorpholine, 1,4-diazabicyclo-[2,2,2]-octane, tin dioctoate or dibutyltin dilaurate.

Salts of zinc, of titanium, of zirconium, of molybdenum and of bismuth can likewise be suitable. The amount of catalyst can be adapted to the requirements of the preparation by the person skilled in the art. Suitable amounts are e.g. 0.002 to 1 wt. %, and the use of from 0.01 to 0.1 wt. % is preferred. The reaction can also be carried out without using a catalyst.

The polyurethane dispersions according to the invention can be used as clear lacquers and/or as pigmented lacquers and coatings and in or as adhesives. In this context, they can be employed as the sole binder, but also in combination with other binders, which are preferably, however, not exclusively in the form of a dispersion.

The present invention therefore also provides binder mixtures comprising the polyurethane dispersions according to the invention.

The polyurethane dispersions according to the invention can also be employed in binder mixtures with other dispersion. These can be dispersions which likewise contain unsaturated groups, such as e.g. dispersions which contain unsaturated, polymerizable groups and are based on polyester, polyurethane, polyepoxide, polyether, polyamide, polysiloxane, polycarbonate, epoxyacrylates, polymer, polyester acrylate, polyurethane polyacrylate and/or polyacrylate.

The binder mixtures according to the invention can also comprise those dispersions e.g. based on polyesters, polyurethanes, polyepoxides, polyethers, polyamides, polyvinyl esters, polyvinyl ethers, polysiloxanes, polycarbonates, polymers and/or polyacrylates which contain functional groups, such as e.g. alkoxysilane groups, hydroxyl groups and/or isocyanate groups optionally present in blocked form. Dual cure systems e.g. which can be cured via two different mechanisms can be prepared in this way.

The binder mixtures according to the invention can also comprise dispersions based on polyesters, polyurethanes, polyepoxides, polyethers, polyamides, polysiloxanes, polyvinyl ethers, polybutadienes, polyisoprenes, chlorinated rubbers, polycarbonates, polyvinyl esters, polyvinyl chlorides, polymers, polyacrylates, polyurethane polyacrylates, polyester acrylates, polyether acrylates, alkyds, polycarbonates, polyepoxides and epoxyacrylates which contain no functional groups. The degree of crosslinking density e.g. can thus be reduced, the physical drying influenced, e.g. accelerated, or elastification or also an adapting of the adhesion carried out.

Coating compositions comprising the polyurethane dispersions according to the invention can also comprise, in the binder mixtures according to the invention, amino crosslinker resins, e.g. based on melamine or urea, and/or polyisocyanates having free or having blocked polyisocyanate groups, e.g. based on polyisocyanates, optionally containing hydrophilizing groups, from hexamethylene-diisocyanate, isophorone-diisocyanate and/or toluoylidene-diisocyanate having urethane, uretdione, iminooxadiazinedione, isocyanurate, biuret and/or allophanate structures.

The polyurethane dispersions according to the invention can also be employed in a mixture with oligomers or polymers which contain unsaturated groups and are not water-soluble or water-dispersible, the oligomers or polymers which contain unsaturated groups and are not water-soluble or water-dispersible being added to the polyurethane dispersions according to the invention before the dispersing, as a result of which the polyurethane dispersions according to the invention serve as polymeric emulsifiers for these substances.

So-called reactive diluents, low-viscosity compounds having unsaturated groups, such as e.g. hexanediol bisacrylate, trimethylolpropane trisacrylate, trimethylolpropane diacrylate, pentaerythritol tetraacrylate, dipentaerythritol hexaacrylate and diepoxide bisacrylates based on bisphenol A, can likewise be suitable for combination with the dispersions according to the invention.

Lacquers, coating systems and adhesives based on the dispersions according to the invention can comprise diverse additives and additional substances, such as e.g. stabilizers, initiators, antioxidants, flow agents, defoamers, wetting agents, accelerators and/or light protection agents.

The invention also provides the use of the polyurethane dispersions according to the invention in or as lacquers and coatings and/or adhesives.

In principle all substrates can be lacquered or coated with the dispersions according to the invention, such as e.g. mineral substrates, wood, wood materials, furniture, parquet, doors, window frames, metallic objects, plastics, paper, cardboard or cork.

The polyurethane dispersions according to the invention can be employed as a one-coat lacquer, as a primer and/or as a top lacquer. They can be applied e.g. by spraying, rolling, dipping, roller application and pouring.

The dispersions according to the invention can also be employed in or as adhesives, e.g. in contact adhesives, in heat-activatable adhesives or in laminating adhesives.

### EXAMPLES

### 1) Preparation of Unsaturated Polyester Resin a1) Modified with Dicyclopentadiene

42.47 parts of maleic anhydride and 22.95 parts of diethylene glycol are weighed into a high-grade steel apparatus with electrical heating, an internal cooling coil, anchor stirrer, reflux condenser, column, glass bridge and nitrogen inlet and passage line, and the mixture is rendered inert with nitrogen, heated to 150° C. in the course of one hour, while passing over nitrogen and utilizing the exothermic reaction, and stirred at this temperature for 1 hour in order to conclude the half-ester formation. After cooling to 140° C., 16.45 parts of dicyclopentadiene are added and the mixture is kept at 140° C. for 4 hours. At the conclusion, the acid number (205+/−5) and OH number (<15) are determined. 5.95 parts of ethylene glycol, 17.73 parts of diethylene glycol and 0.2 part of toluhydroquinone are then added. The mixture is heated up to 190° C. such that the overhead temperature does not rise above 105° C., and this temperature is maintained until an acid number of approx. 12 and a hydroxyl number of from 105 to 125 mg KOH/g of substance are achieved by esterification. After cooling to 150° C., 0.1 part of toluhydroquinone and 0.03 part of trimethylhydroquinone are added. The mixture is then cooled further to 55° C. and dissolved in acetone. An approx. 72% strength solution of an unsaturated polyester resin a1) modified with dicyclopentadiene results.

### 2) Preparation of a UV-Curable Aqueous Polyurethane Dispersion 2) Based on an Unsaturated Polyester Resin Modified with Dicyclopentadiene

158.4 parts of the acetone solution of component a1) prepared in Example 1), 425.6 parts of the polyester acrylate Laromer® PE44F (BASF AG, Ludwigshafen, DE), component d), 26.8 parts of dimethylolpropionic acid, component c), 50.4 parts of hexamethylene-diisocyanate and 102.2 parts of isophorone-diisocyanate, component b) and 0.6 part of dibutyltin dilaurate are dissolved in 180 parts of acetone and are reacted at 50° C., while stirring, to an NCO content of 1.6 wt. %. 20.2 parts of triethylamine are added to and stirred into the prepolymer solution obtained in this way. The clear solution formed is then introduced into 1,100 parts of distilled water, while stirring. A mixture of 10.2 parts of ethylenediamine, component g) and 31.0 parts of water is then added to the dispersion, while stirring. The acetone is subsequently distilled off from the dispersion under a slight vacuum. A polyurethane dispersion 2) containing an unsaturated polyester modified with dicyclopentadiene and having a solids content of 42 wt. %, an average particle size of approx. 125 nm and a pH of 7.9 is obtained.

### Use Testing:

| | |
|---|---|
| Dispersion | 2 |
| Storage stability: | |
| 50° C./24 hours | OK |
| 40° C./28 days | OK |
| Resistance to water: | 5 |
| (exposure for 16 hours) | |
| Resistance to coffee: | 5 |
| (exposure for 16 hours) | |
| Resistance to ethanol/water (1:1 | 4 |
| mixture) | |
| (exposure for 16 hours) | |
| Resistance to red wine: | 4 |
| (exposure for 16 hours) | |
| Physical drying | OK |
| to a tack-free film | |
| Reactivity (pendulum hardness) | 164/157/118 sec |
| Warmth and brilliance | 5 |
| Adhesion | 5 |
| Chalking after scratching | 5 |

Rating levels: 0 to 5
5 = excellent;
4 = very good;
3 = good;
2 = adequate;
1 = weak;
0 = very poor

For the use testing, the dispersions according to the invention are tested in a simple formulation comprising in each case a homogeneous mixture of 100 g dispersion and 1 g photoinitiator (Irgacure® 500, Ciba, Lampertheim, DE).

The determination of the resistance properties is carried out on beech as the substrate.

The warmth and brilliance on the wood background is evaluated on sapelli as the substrate by visual inspection and comparison to a standard by a trained and experienced lacquer technician.

Application is by application of 2×150 μm wet films with a box-type doctor blade in cross-application. Drying is carried out for 10 min/50° C. per application. Intermediate sanding is carried out with 400 grade sandpaper.

After drying for 10 min/50° C. (or 1 hour/25° C.), the physical drying is determined. If the film is tack-free after the drying, the physical drying is OK. Pendulum hardnesses can then also be determined, which are conventionally in the range of from 5 to 30 s.

The UV curing is carried out by means of an Hg lamp at 80 W/cm at a belt speed of 5 m/min. The finished panels are then stored for 16 h at RT and subsequently subjected to the tests.

The pendulum hardness or pendulum damping is measured in pendulum seconds by the method of König (DIN 53157).

The adhesion is determined by the cross-hatch test (DIN 53151). CT 0 is evaluated as excellent adhesion (=rating 5).

The chalking after scratching is tested by scratching with a coin. If no chalking at all is detectable at the scratching point, this result is evaluated as excellent (rating 5).

The reactivity is determined by increasing the belt speed (5 n/min; 10 m/min; 15 m/min) and measuring the pendulum hardness achieved each time. If a pendulum hardness of >100 s is achieved even at a high belt speed, the dispersion is distinguished by a high reactivity.

### 3) Preparation of a UV-Curable Aqueous Polyurethane Dispersion 3) Based on an Unsaturated Polyester Resin Modified with Dicyclopentadiene

158.4 parts of the acetone solution of component a1) prepared in Example 1), 425.6 parts of the polyester acrylate Laromer® PE 44 F (BASF AG, to Ludwigshafen, DE) d), 26.8 parts of dimethylolpropionic acid and 12.3 parts of Polyether LB 25 (Bayer MaterialScience AG, Leverkusen, DE) c), 50.4 parts of hexamethylene-diisocyanate and 102.2 parts of isophorone-diisocyanate b) and 0.6 part of tin dioctoate are dissolved in 140 parts of acetone and are reacted at 50° C., while stirring, to an NCO content of 1.6 wt. %. 20.2 parts of triethylamine are added to and stirred into the prepolymer solution obtained in this way. The clear solution formed is then introduced into 1,100 parts of distilled water, while stirring, and a mixture of 10.2 parts of ethylenediamine, component f) and 31.0 parts of water is added to the dispersion. Finally, the acetone is distilled off from the dispersion under a slight vacuum. A polyurethane dispersion 3) containing an unsaturated polyester modified with dicyclopentadiene and having a solids content of 40.7 wt. %, an average particle size of approx. 96 nm and a pH of 8.2 is obtained.

### 4) Preparation of a UV-Curable Aqueous Polyurethane Dispersion 4) based on an unsaturated polyester resin modified with dicyclopentadiene

158.4 parts of the acetone solution of component a1) prepared in Example 1), 425.6 parts of the polyester acrylate Laromer® PE 44 F (BASF AG, Ludwigshafen, DE) d), 26.8 parts of dimethylolpropionic acid c), 45.4 parts of hexamethylene-diisocyanate and 94.4 parts of isophorone-diisocyanate b) and 0.6 part of dibutyltin dilaurate are dissolved in 180 parts of acetone and are reacted at 50° C., while stirring, to an NCO content of 1.2 wt. %. 20.2 parts of triethylamine are added to and stirred into the prepolymer solution obtained in this way. The clear solution formed is then introduced into 1,100 parts of distilled water, while stirring, and a mixture of 6.6 parts of ethylenediamine, component f) and 31.0 parts of water is added to the dispersion. Finally, the acetone is distilled off from the dispersion under a slight vacuum. A polyurethane dispersion 4) containing an unsaturated polyester modified with dicyclopentadiene and having a solids content of 41.2 wt. %, an average particle size of approx. 170 nm and a pH of 8.3 is obtained.

### 5) Preparation of Polyester Acrylate d1)

797 parts of maleic anhydride, 6,006 parts of the polyether Desmophen® 4011 T (propoxylated trimethylolpropane, OH number 550 mg of KOH/g of substance; Bayer MaterialScience AG; Germany), 2,106 parts of acrylic acid, 3,642 parts of isooctane, 85.3 parts of toluenesulfonic acid and 26.2 parts of di-tert-butylhydroquinone are weighed into a high-grade steel apparatus with electrical heating, an internal cooling coil, anchor stirrer, reflux condenser, glass bridge, water sack and nitrogen inlet and passage line, and the mixture is heated under reflux at 95-105° C., while passing over air and nitrogen. After approx. 20 hours, an acid number of <5 is reached, and the mixture is cooled to 50° C. Thereafter, the solvent is distilled off over a column at initially 50° C. and later 90° C. in vacuo, and the mixture is then aerated and cooled to 40° C. Polyester acrylate dl) results.

### 6) Preparation of a UV-Curable Aqueous Polyurethane Dispersion 2) Based on an Unsaturated Polyester Resin Modified with Dicyclopentadiene

158.4 parts of the acetone solution of component a1) prepared in Example 1), 300.3 parts of polyester acrylate dl) prepared in Example 5), 26.8 parts of dimethylolpropionic acid c), 50.4 parts of hexamethylene-diisocyanate and 102.2 parts of isophorone-diisocyanate b) and 0.6 part of dibutyltin dilaurate are dissolved in 140 parts of acetone and are reacted at 50° C., while stirring, to an NCO content of 1.6 wt. %. 18.2 parts of triethylamine are added to and stirred into the prepolymer solution obtained in this way. The clear solution formed is then introduced into 940 parts of distilled water, while stirring, and a mixture of 10.2 parts of ethylenediamine f) and 31.0 parts of water is added to the dispersion. Finally, the acetone is distilled off from the dispersion under a slight vacuum. A polyurethane dispersion 6) containing an unsaturated polyester modified with dicyclopentadiene and having a solids content of 42.6 wt. %, an average particle size of approx. 135 nm and a pH of 8.0 is obtained.

### 7) Preparation of Unsaturated Polyester Resin a2) Modified with Dicyclopentadiene

43.88 parts of maleic anhydride, 6.44 parts of ethylene glycol, 39.84 parts of diethylene glycol and 0.01 part of toluhydroquinone are weighed into a high-grade steel apparatus with electrical heating, an internal cooling coil, anchor stirrer, reflux condenser, column, glass bridge and nitrogen inlet and passage line, and the mixture is rendered inert with nitrogen and heated to 190° C., while passing over nitrogen and utilizing the exothermic reaction. During this operation the overhead temperature does not rise above 105° C. This temperature is maintained until an acid number of approx. 75 is achieved by esterification. After cooling to 150° C., 17.89 parts of dicyclopentadiene are added and the mixture is kept at 170° C. for 5 hours. A column with a bridge is then mounted on the apparatus and the temperature is kept at 205° C. for several hours, until the acid number has fallen to below 22 mg/g of substance. After cooling to 80° C., 0.01 part of toluhydroquinone is added. The mixture is then cooled further to 55° C. and dissolved in acetone. An approx. 70% strength solution of an unsaturated polyester resin a2) modified with dicyclopentadiene results.

### 8) Preparation of a UV-Curable Aqueous Polyurethane Dispersion 8) Based on an Unsaturated Polyester Resin Modified with Dicyclopentadiene

242.6 parts of the acetone solution of component a2) prepared in Example 7), 425.6 parts of the polyester acrylate Laromer® PE 44 F (BASF AG, Ludwigshafen, DE) d), 26.8 parts of dimethylolpropionic acid c), 50.4 parts of hexamethylene-diisocyanate and 102.2 parts of isophorone-diisocyanate b) and 0.6 part of dibutyltin dilaurate are dissolved in 180 parts of acetone and are reacted at 50° C., while stirring, to an NCO content of 1.6 wt. %. 20.2 parts of triethylamine are added to and stirred into the prepolymer solution obtained in this way. The clear solution formed is then introduced into 1,150 parts of distilled water, while stirring, and a mixture of 10.2 parts of ethylenediamine f) and 31.0 parts of water is added to the dispersion. Finally, the acetone is distilled off from the dispersion under a slight vacuum. A polyurethane dispersion 8) containing an unsaturated polyester modified with dicyclopentadiene and having a solids content of 41.4 wt. %, an average particle size of approx. 160 nm and a pH of 8.4 is obtained.

### 9) Preparation of Unsaturated Polyester Resin a3) Modified with Dicyclopentadiene

30.08 parts of maleic anhydride, 15.14 parts of phthalic anhydride and 20.20 parts of diethylene glycol are weighed into a high-grade steel apparatus with electrical heating, an internal cooling coil, anchor stirrer, reflux condenser, column, glass bridge and nitrogen inlet and passage line, and the mixture is rendered inert with nitrogen, heated to 150° C. in the course of one hour, while passing over nitrogen and utilizing the exothermic reaction, and stirred at this temperature for 1 hour in order to conclude the half-ester formation. After cooling to 140° C., 16.46 parts of dicyclopentadiene are added and the mixture is kept at 140° C. for 4 hours. At the conclusion, the acid number (205+/−5) and OH number (<15) are determined. 5.95 parts of ethylene glycol, 17.73 parts of diethylene glycol and 0.02 part of toluhydroquinone are then added. The mixture is heated up to 190° C. such that the overhead temperature does not rise above 105° C., and this temperature is maintained until an acid number of approx. 12 and an OH number of from 105 to 125 mg KOH/g of substance are achieved by esterification. After cooling to 150° C., 0.03 part of toluhydroquinone and 0.03 part of trimethylhydroquinone are added. The mixture is then cooled further to 55° C. and dissolved in acetone. An approx. 72% strength solution of an unsaturated polyester resin a3) modified with dicyclopentadiene results.

### 10) Preparation of a UV-Curable Aqueous Polyurethane Dispersion 10) Based on an Unsaturated Polyester Resin Modified with Dicyclopentadiene

122.4 parts of the acetone solution of component a3) prepared in Example 9), 425.6 parts of the polyester acrylate Laromer® PE 44 F (BASF AG, Ludwigshafen, DE) d), 26.8 parts of dimethylolpropionic acid c), 50.4 parts of hexamethylene-diisocyanate and 102.2 parts of isophorone-diisocyanate b) and 0.6 part of dibutyltin dilaurate are dissolved in 180 parts of acetone and are reacted at 50° C., while stirring, to an NCO content of 1.6 wt. %. 20.2 parts of triethylamine are added to and stirred into the prepolymer solution obtained in this way. The clear solution formed is then introduced into 1,100 parts of distilled water, while stirring, and a mixture of 10.2 parts of ethylenediamine f) and 31.0 parts of water is added to the dispersion. Finally, the acetone is distilled off from the dispersion under a slight vacuum. A polyurethane dispersion 10) containing an unsaturated polyester modified with dicyclopentadiene and having a solids content of 40.9 wt. %, an average particle size of approx. 168 nm and a pH of 8.2 is obtained.

### 11) Preparation of Unsaturated Polyester Resin a4) Modified with Dicyclopentadiene

41.32 parts of maleic anhydride and 24.07 parts of 1,6-hexanediol are weighed into a high-grade steel apparatus with electrical heating, an internal cooling coil, anchor stirrer, reflux condenser, column, glass bridge and nitrogen inlet and passage line, and the mixture is rendered inert with nitrogen, heated to 150° C. in the course of one hour, while passing over nitrogen and utilizing the exothermic reaction, and stirred at this temperature for 1 hour in order to conclude the half-ester formation. After cooling to 140° C., 16.45 parts of dicyclopentadiene are added and the mixture is kept at 140° C. for 4 hours. At the conclusion, the acid number (205+/−5) and OH number (<15) are determined. 5.49 parts of ethylene glycol, 18.2 parts of 1,6-hexanediol and 0.02 part of toluhydroquinone are then added. The mixture is heated up to 190° C. such that the overhead temperature does not rise above 105° C., and this temperature is maintained until an acid number of approx. 12 and an OH number of from 105 to 125 mg KOH/g of substance are achieved by esterification. After cooling to 150° C., 0.03 part of toluhydroquinone and 0.03 part of trimethylhydroquinone are added. The mixture is then cooled further to 55° C. and dissolved in acetone. An approx. 72% strength solution of an unsaturated polyester resin a4) modified with dicyclopentadiene results.

### 12) Preparation of a UV-Curable Aqueous Polyurethane Dispersion 2) Based on an Unsaturated Polyester Resin Modified with Dicyclopentadiene

147.5 parts of the acetone solution of component a4) prepared in Example 11), 425.6 parts of the polyester acrylate Laromer® PE 44 F (BASF AG, Ludwigshafen, DE), 26.8 parts of dimethylolpropionic acid c), 50.4 parts of hexamethylene-diisocyanate and 102.2 parts of isophorone-diisocyanate b) and 0.6 part of dibutyltin dilaurate are dissolved in 180 parts of acetone and are reacted at 50° C., while stirring, to an NCO content of 1.6 wt. %. 20.2 parts of triethylamine are added to and stirred into the prepolymer solution obtained in this way. The clear solution formed is then introduced into 1,100 parts of distilled water, while stirring, and a mixture of 10.2 parts of ethylenediamine f) and 31.0 parts of water is added to the dispersion. Finally, the acetone is distilled off from the dispersion under a slight vacuum. A polyurethane dispersion 12) containing an unsaturated polyester modified with dicyclopentadiene and having a solids content of 41.6 wt. %, an average particle size of approx. 138 nm and a pH of 8.5 is obtained.

### Use Testing:

| | | | | | | |
|---|---|---|---|---|---|---|
| Dispersion | 3 | 4 | 6 | 8 | 10 | 12 |
| Storage stability: | | | | | | |
| 50° C./24 hours | OK | OK | OK | OK | OK | OK |
| 40° C./28 days | OK | OK | OK | OK | OK | OK |
| Resistance to water: | 5 | 5 | 5 | 5 | 5 | 5 |
| (exposure for 16 hours) | | | | | | |
| Resistance to coffee: | 5 | 5 | 5 | 4 | 5 | 5 |
| (exposure for 16 hours) | | | | | | |
| Resistance to ethanol/ | 5 | 5 | 4 | 4 | 4 | 4/5 |
| water (1:1 mixture) | | | | | | |
| (exposure for 16 hours) | | | | | | |
| Resistance to red wine: | 4 | 5 | 4 | 4 | 5 | 5 |
| (exposure for 16 hours) | | | | | | |
| Physical drying | OK | OK | OK | OK | OK | OK |
| to a tack-free film | | | | | | |
| Reactivity (pendulum | 161/ | 154/ | 162/ | 162/ | 160/ | 147/ |
| hardness) | 151/ | 137/ | 140/ | 151/ | 148/ | 144/ |
| | 120 sec | 111 | 102 sec | 122 | 130 | 105 |
| | | sec | | sec | sec | sec |
| Warmth and brilliance | 4/5 | 4/5 | 4 | 5 | 4/5 | 4/5 |
| Adhesion | 5 | 5 | 5 | 5 | 4 | 5 |
| Chalking after scratching | 5 | 5 | 5 | 5 | 5 | 5 |

Rating levels: 0 to 5
5 = excellent;
4 = very good;
3 = good;
2 = adequate;
1 = weak;
0 = very poor

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane dispersion prepared from unsaturated polyester resins modified with dicyclopentadiene.

2. An aqueous polyurethane dispersion according to claim 1, wherein the polyurethane is the reaction product of
a) at least one unsaturated polyester resin modified with
dicyclopentadiene,
b) at least one at least difunctional polyisocyanate and
c) at least one hydrophilizing component.

3. An aqueous polyurethane dispersion according to claim 1, wherein the polyurethane is the reaction product of
a) at least one unsaturated polyester resin modified with dicyclopentadiene,
b) at least one at least difunctional polyisocyanate,
c) at least one hydrophilizing component having at least one hydroxyl, amino and/or thio group and at least one ionic or potentially ionic group and/or ethylene oxide, ethylene oxide/propylene oxide copolymer and/or block copolymer structural units,
d) at least one component selected from the group consisting of (poly)ester (meth)acrylates, (poly)ether (meth)acrylates, (poly)urethane (meth)acrylates, (poly)epoxy(meth)acrylates, (poly)ether ester (meth)acrylates and unsaturated polyesters having allyl ether structural units,
e) optionally hydroxy-functional diols and/or triols of number average molecular weight 62 to 242 and/or hydroxy-functional oligomers or polymers selected from the group consisting of polyesters, polycarbonates, polyurethanes, C2-, C3- and/or C4-polyethers, polyether esters and polycarbonate polyesters of number-average molecular weight 700 to 4,000 g/mol and
f) at least one mono-, di- and/or polyamine and/or hydroxyamine.

4. An aqueous polyurethane dispersion according to claim 3, wherein
component a) is at least one unsaturated polyester resin which is modified with 5 to 35 wt. % of dicyclopentadiene,
component b) is at least one at least difunctional polyisocyanate which comprises at least 60 wt. % aliphatic and/or cycloaliphatic polyisocyanates,
component d) is at least one compound chosen from the group consisting of polyester acrylates, polyether acrylates, polyepoxyacrylates, urethane acrylates and/or polyether ester acrylates, which also contains hydroxyl groups in addition to the unsaturated groups.

5. An aqueous polyurethane dispersion according to claim 1, wherein the polyurethane is further prepared from at least one initiator and optionally auxiliary substances and additives which allow the polyurethane to be cured with UV radiation.

6. An aqueous polyurethane dispersion according to claim 3, wherein the polyurethane is the reaction product of
3 to 50 wt. % of component a), 7 to 50 wt. % of component b), 1 to 25 wt. % of component c), 10 to 75 wt. % of component d), 0 to 40 wt. % of component e) and 0.1 to 6 wt. % of component f),
the percentages of a) to f) adding up to 100 wt. %.

7. An aqueous polyurethane dispersion according to claim 1, wherein the dispersion contains less than 5 wt. % of organic solvents.

8. A process for the preparation of the polyurethane dispersion according to claim 3, comprising forming an isocyanate-functional prepolymer by reacting components a), c), optionally d) and e) with an excess of component b) in one or more reaction steps, adding a neutralizing agent for producing the ionic groups necessary for the dispersing to the reactants before, during or after this prepolymer formation, dispersing the prepolymer in water, optionally chain extending the prepolymer by adding component f).

9. A binder mixture comprising a polyurethane dispersion according to claim 1.

10. A coating composition comprising a polyurethane dispersion according to claim 1 and a crosslinking agent.
